(19) United States
(12) Patent Application Publication
(10) Pub. No.: US 2021/0248561 A1
(43) Pub. Date: Aug. 12, 2021

(54) USER INTERFACE USING GRAPHICAL DIALS TO REPRESENT USER ACTIVITY

(71) Applicant: DIALS, LLC, Dover, DE (US)

(72) Inventors: Thomas Scriven, Los Angeles, CA (US); Dante Orpilla, San Diego, CA (US)

(21) Appl. No.: 17/242,463

(22) Filed: Apr. 28, 2021

Related U.S. Application Data
(63) Continuation of application No. 14/558,667, filed on Dec. 2, 2014.
(60) Provisional application No. 62/086,628, filed on Dec. 2, 2014.
(60) Provisional application No. 61/910,882, filed on Dec. 2, 2013.

(51) Int. Cl. G06Q 10/10; G04G 21/08; G04G 13/02; G04G 11/00

(52) U.S. Cl. CPC G06Q 10/1093; G04G 21/08; G04G 11/00; G04G 13/026; G06Q 10/109

(57) ABSTRACT

A time management system includes a graphical user interface generated by an application on a mobile computing device. The graphical user interface is displayed on a touch-sensitive display of the mobile computing device and includes a substantially circular dial. The dial has an outer region and an inner region circumscribed by the outer region, the outer region representing a time domain and displaying one or more icons thereon to represent an associated one or more events to occur at a time of the time domain. The inner region displays information relating to at least one user selected event represented by the one or more icons in the outer region.

### CROSS-REFERENCE TO RELATED APPLICATIONS

This application claims priority under 35 U.S.C. § 119(e) to U.S. Provisional Patent Application Ser. No. 61/910,882 filed on Dec. 2, 2013 and entitled “User Interface Using Graphical Dials to Represent User Activity” and under 35 U.S.C. § 119(e) to U.S. provisional patent application Ser. No. 62/086,628 filed on Dec. 2, 2014 and entitled “User Interface Using Graphical Dials to Represent User Activity”, the disclosure of each of the documents identified is incorporated by reference herein in its entirety.

### TECHNICAL FIELD

The subject matter described herein relates to time management systems for personal computing devices, and more particularly to a user interface for time management systems in which time-based information, such as events like meetings, calls, and tasks, is displayed in a graphical dial that represents units of time.

### BACKGROUND

Every single human action has a time component. Since the beginning of time, people have organized their daily activities using a variety of time management systems. One of the earliest and most universally-recognized representations of time is a circular dial, such as a sun dial or clock face. While such an interface is still widely used for telling time, in this modern age, people structure their schedules and manage their time most often with a calendar.

Since the advent of the digital computer and the graphical user interface (GUI), personal computing devices offer personal time management systems in the form of a calendar application or calendar program executed by the computing device. Conventional calendar applications receive time-based information in the form of text, and display a user activity in a linear or tabular format of a common calendar.

However, conventional calendar applications are counterintuitive, cumbersome and cluttered, especially for mobile computing devices such as smartphones and tablet computers, and “wearable” computers such as watches, bracelets, or the like. The user interfaces of current calendar applications do not scale well to the display format of a mobile computing device or wearable computer. For instance, a top-down interface does not allow the user to view a full day without scrolling through the display. Events are received and displayed as text. On a mobile computing device, for example, the text can be very small, and very difficult to read. Further, conventional calendars for mobile computing devices do not have real-time in-application notifications. Change notifications are typically reliant on other programs, such as email response, text message notification, etc. As a result, many changes, rescheduling, or other event information often gets lost, left out, or ignored.

### SUMMARY

This document discloses a time management system for a computing device in which time-based information, such as events like meetings, calls, and tasks, is displayed in a graphical user interface having a graphical dial that represents units of time. The dial is preferably circular, to represent a clock face, such as a twelve-hour clock face. An outer region of the dial represents units of time, while an inner region of the dial, circumscribed by the outer region, provides information about events that are related to the units of time.

In one aspect, a time management system includes a graphical user interface generated by an application on a mobile computing device. The graphical user interface is displayed on a touch-sensitive display of the mobile computing device and includes a substantially circular dial. The dial has an outer region and an inner region circumscribed by the outer region, the outer region representing a time domain and displaying one or more icons thereon to represent an associated one or more events to occur at a time of the time domain. The inner region displays information relating to at least one user selected event represented by the one or more icons in the outer region, the inner region further providing interactive controls for editing the information relating to the at least one user selected event.

In another aspect, a graphical user interface is generated by an application on a mobile computing device. The graphical user interface is displayed on a touch-sensitive display of the mobile computing device and includes a substantially circular graphical dial, the dial having an outer region and an inner region circumscribed by the outer region. The outer region represents a twelve-hour clock face and displays one or more icons thereon to represent an associated one or more events to occur at a time and duration of the time domain. Each event is designated by a start icon and an end icon, the start icon originating in the graphical user interface at the twelve o'clock position by the application and being movable clockwise or counter-clockwise on the graphical dial to designate a PM or an AM start time of the event, respectively.

Implementations of the current subject matter can include, but are not limited to, systems and methods consistent with one or more features described herein, as well as articles that comprise a tangibly embodied machine-readable medium operable to cause one or more machines (e.g., computers, etc.) to result in operations described herein. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to an enterprise resource software system or other business software solution or architecture, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates a time management system 100 in accordance with some implementations of the subject matter described herein.

FIGS. 2A-E illustrate several basic features of a time management system 200 consistent with implementations described herein.

FIG. 3 illustrates a home screen of an application program of a time management system.

FIGS. 4A-AN illustrate various features and functionality of a time management system, as implemented as a mobile application running on a mobile computing device.

FIG. 5 illustrates functions of switching views in the graphical user interface of the mobile application.

FIG. 6 illustrates an interface of a time management system in accordance with some implementations.

FIG. 7 illustrates another interface of a time management system in accordance with some implementations.

FIG. 8 illustrates yet another interface of a time management system in accordance with some implementations.

When practical, similar reference numbers denote similar structures, features, or elements.

### DETAILED DESCRIPTION

To address the aforementioned issues with currently available solutions, methods, systems, articles of manufacture, and the like consistent with one or more implementations of the current subject matter can, among other possible advantages, provide a graphical representation of a dial in a user interface of a computer-implemented time management system. The dial represents units of time, and in preferred implementations represents a conventional 12-hour clock face or watch dial. Information, such as events like meetings, calls, and tasks, is displayed in the dial relative to points of time of the units of time.

In particular, this document describes a time management system for a computing device in which time-based information, such as events like meetings, calls, tasks, or the like, is displayed in a graphical user interface having a graphical dial that represents units of time. The dial is preferably circular, to represent a standard clock face, such as a twelve-hour clock face. An outer region of the dial represents units of time, such as twelve hours and/or 15 minute increments. An inner region of the dial, circumscribed by the outer region, provides information about events that are related to the units of time, such as a start time and/or duration of each event.

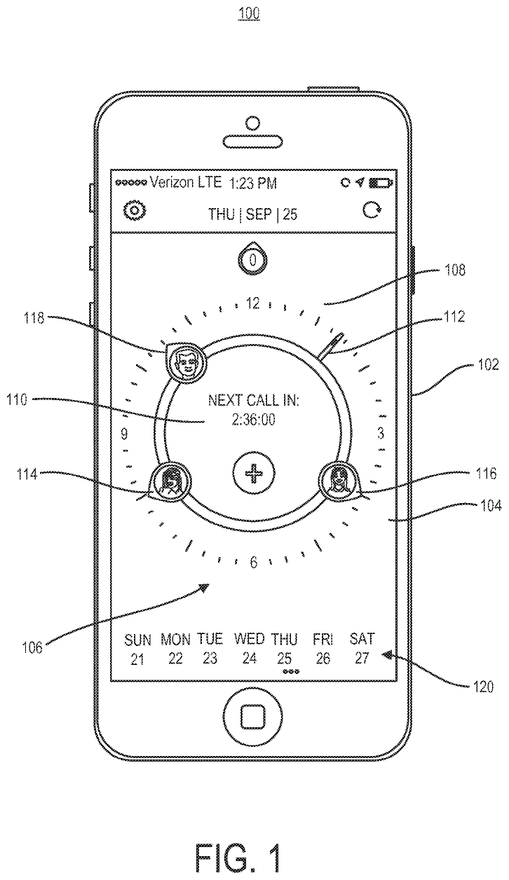

FIG. 1 illustrates a time management system 100 in accordance with some implementations of the subject matter described herein. The time management system 100 is implemented as an application program executed by, or running on, a computing device 102, preferably a mobile computing device or wearable computer, which have small displays and constrained areas for displaying information in a GUI. The computing device 102 includes a graphical display 104, preferably a touch-screen display. The graphical display 104 includes a dial 106 that is graphically rendered by one or more data processors forming part of the computing device 102.

The dial 106 is preferably circular, to represent a standard clock face, such as a twelve-hour clock face as shown in FIG. 1. The dial 106 includes an outer region 108 that graphically represents units of time, such as one hour and/or twelve hours. The dial 106 can represent other units of time, such as 24 hours, for example. The units of time can be represented in any time increments, such as one minute, five minutes, and/or 15 minutes. The display of the units of time can be dynamically adjusted based on user input and control. Events can be graphically represented on the outer region, such as a start time and/or duration of each event. The dial 106 further includes an inner region 110, circumscribed by the outer region 108. The inner region 110 provides graphical or textual information about selected events that are associated with the units of time. The event can be selected based on any of a number of attributes, such as next event, or by designated importance, or the like. The outer region 108 can further include a time-of-day designator 112, such as graphical representation of a minute and/or hour hand.

In accordance with some implementations, the events that are associated with the dial 106 can be designated as being one of a meeting 112, a phone call 114 or other communication, and a task 116. Other designations or sub-categories can be applied, such task type, meeting type, importance or urgency of an event, a number of participants to an event, event category (such as business meeting, social event, or the like), to-do lists, or other designations. Each event can be depicted by a graphical representation, such as a logo, image of a participant, or textual representation. As illustrated in FIG. 1, each event is depicted by a small circle containing a graphical representation of a participant or location of the event, with a pointer that clearly and unambiguously shows a start time and/or duration of the event according to the units of time represented by the outer region 108 of the dial 106.

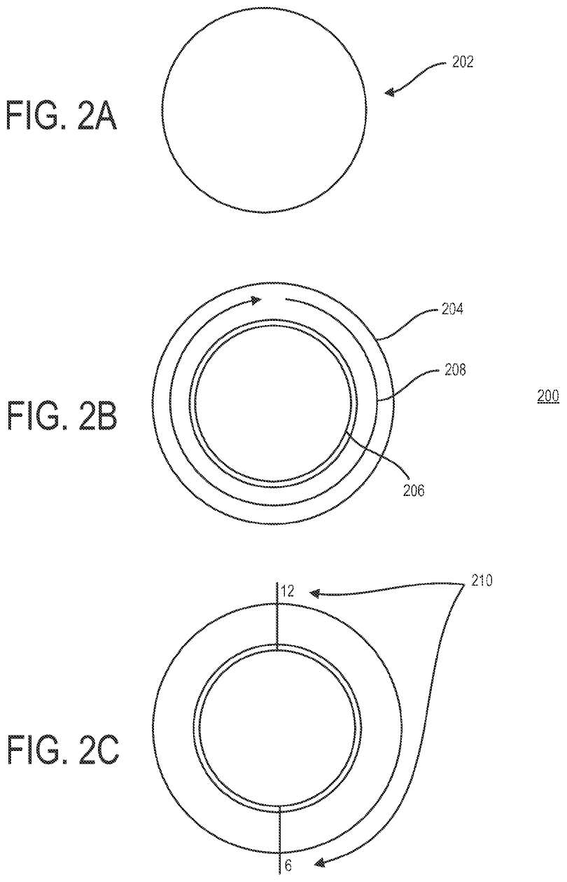

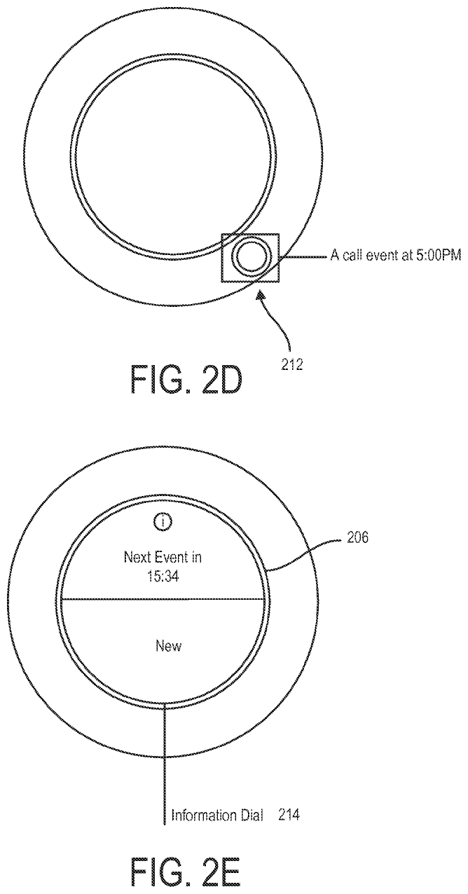

FIGS. 2A-E illustrate several basic features of a time management system 200 consistent with implementations described herein. As shown in FIG. 2A, the time management system 200 can include a graphical representation of a dial 202, preferably as a circle. As shown in FIG. 2B, the dial 202 includes an outer region 204 defined by an outer boundary and an inner boundary, and an inner region 206 as the region in the GUI inside of the inner boundary of the outer region 204. The outer boundary and inner boundary of the outer region 204 defines a time-based interface 208, the circumference of which represents a predetermined duration of time, such as 12 hours, although any duration can be defined. The duration defined or represented by the outer region 204 can be graphically subdivided into time increments, such as equal increments of one hour. The time-based interface 208 is interactive, such as a touch-sensitive area of a touch-sensitive display, in which a user can input user commands and data input, such as by touching a display of the dial 202 with their finger, a stylus, or other input implement.

As shown in FIG. 2C, the outer region 204 graphically represents units of time or discreet time increments. The units of time can be seconds, minutes, hours, days, months or other units of time. In preferred implementations, the units of time can be hours, and the outer region 204 of the dial 202 can be divided into twelve hours (i.e. 12 o'clock to 12 o'clock), as illustrated in FIG. 2C. By user input, such as by swiping a touch-sensitive display that displays the dial 202, the representation of the units of time can be adjusted, i.e. from 12 hours to 24 hours, or from 12 hours to one hour. However, in preferred implementations, the outer region 204 displays units of time consistent with a conventional watch face, i.e., 12 hours and can further represent increments of one or more minutes.

FIG. 2D illustrates a positioning of an event 212 within a particular part of the outer region 204, as associated with a particular unit or duration of time represented thereby. The event 212 can be any graphical representation, including, but not limited to, an image, an icon, text, a geographical shape, a pointer, or any other representation. Further, the event can be color coded as to event type, such as red for meetings, yellow for calls, and green for tasks. By designating the event to only three event types can provide visual context to the events for quick determination by a user as to the context. In some implementations, a user can input text when setting an event, and the time management system 200 can convert the text to a graphic such as an image. For example, if the text is a name, the system 200 will automatically pull a profile picture related to the name from user's contacts stored in a memory associated with their computing device. If the text is a location, such as a nearby café or coffee shop, the system 200 can search the Internet for a logo or other pictorial representation of the location. In this way, the context of any event 212 that is depicted in the dial, such as which whom the event is related, where the event is to occur, etc., can be immediately and quickly discerned by the user.

FIG. 2E illustrates information that can be contained in the inner region 206 of the dial 202. The inner region 206 can include visual prompts for user input for new events or edits to existing events, as well as information about existing events, such as a time when the user's next event is to occur. The inner region 206 can also be used for providing marketing or advertising information by a sponsor associated with the application that generates the dial 202, or associated with an event (such as a location of a meeting, for example).

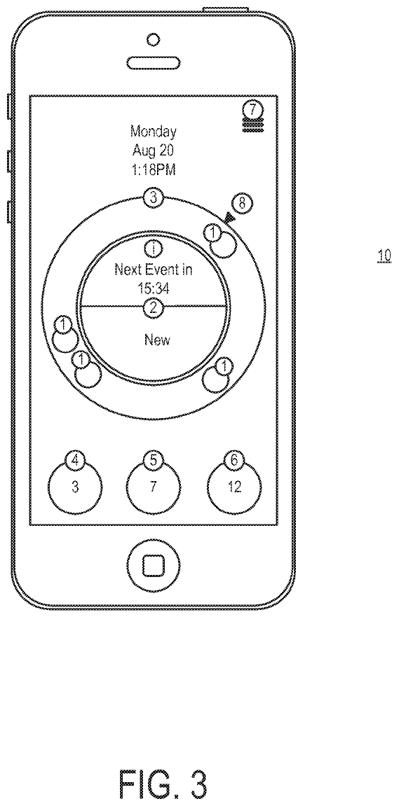

FIG. 3 illustrates a home screen 10 of an application program of a time management system. The application program is preferably a “mobile app,” i.e., an application program that can be downloaded from an application store or the like to a mobile computing device. Such mobile apps are specifically tailored for a particular mobile computing device platform, which includes the hardware such as display screen, data processors, and battery, firmware and software, such as the operating system and other applications. The home screen 10 includes event icons 1, which are displayed within, on or near the outer region of the dial. The home screen 10 also includes an information dial 2, which is displayed within the inner region of the dial, and a time dial 3 that represents a duration of time.

The home screen 10 further includes event indicators such as a call dial 4 that represents phone calls or other electronic communication that are scheduled or needing to be scheduled by a user using the dial, an appointment dial 5 that represents appointments that are scheduled or needing to be scheduled by the user, and a task dial 6 that represents tasks that are scheduled or needing to be scheduled by the user. The tasks can include “to-do” lists, deadlines, reminders, etc. The home screen 10 further includes a list view toggle control 7, and a time indicator 8 that indicates a present time of day relative to the time dial 3. The functions of these and other features will be explained in further detail below.

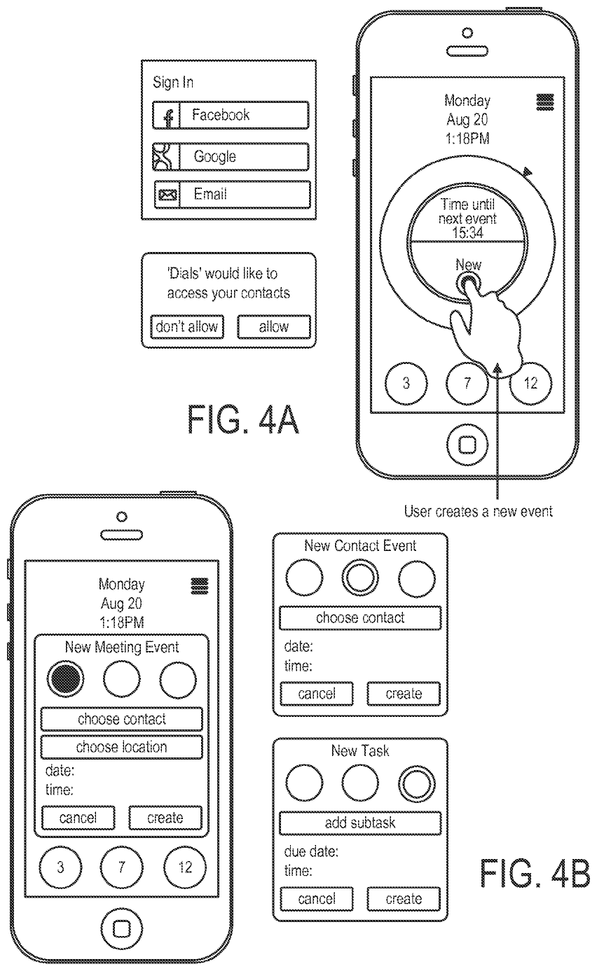

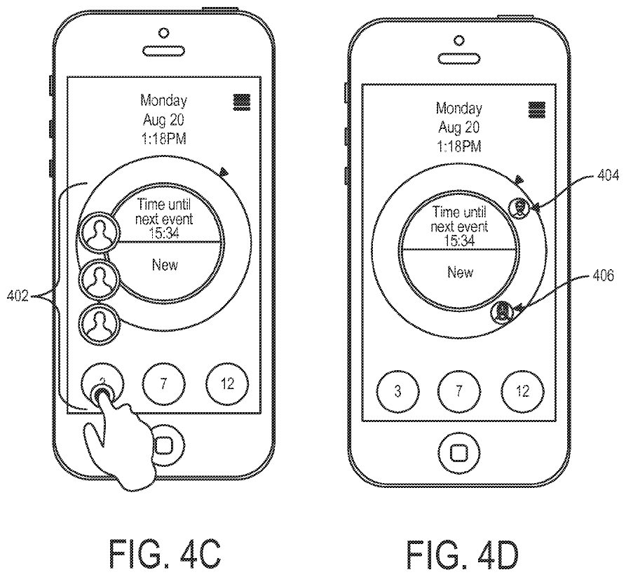

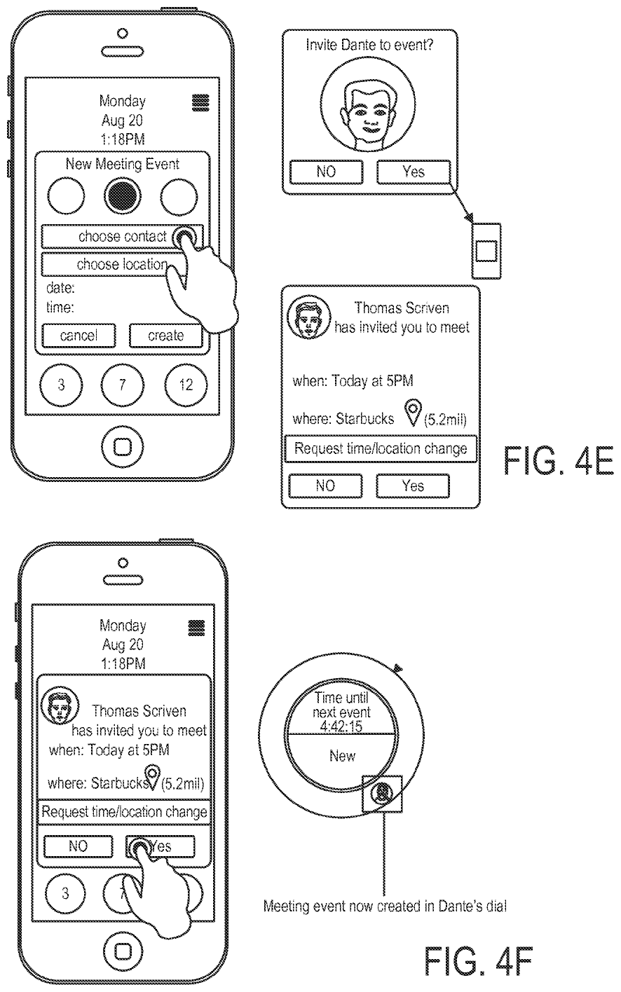

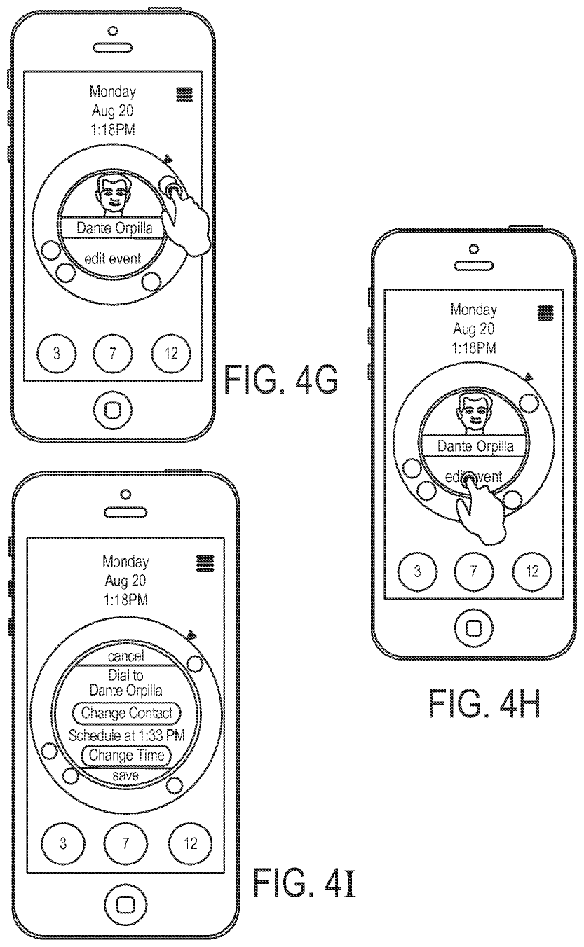

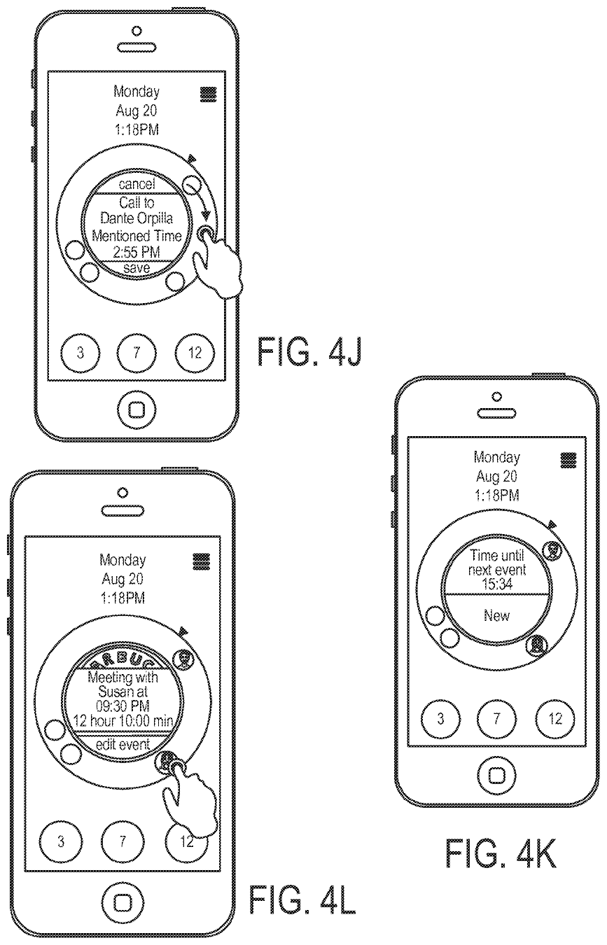

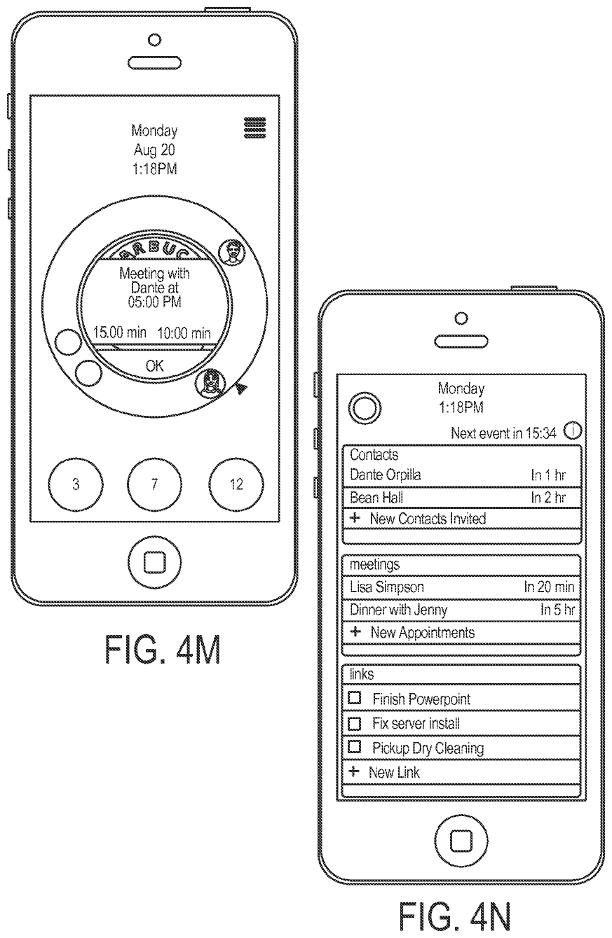

FIGS. 4A-AN illustrate various features and functionality of a time management system, as implemented as a mobile app (hereafter “the app”) running on a mobile computing device. As shown in FIG. 4A, upon launch, the app prompts the user to login. The login can be done directly with the app, or via a social networking service such as Facebook®, Google®, or email. The app also prompts the user for access to the users contacts, which can be stored locally on the mobile computing device or remotely and accessible by a communication network. Once the app has pulled this information, the information is synchronized for access by and use within the app.

FIG. 4B illustrates a function of creating a new event. Whenever a user creates a new event, the app prompts the user to define which of any of a number of categories the event is associated with. In some implementations, the categories are defined as a meeting (which can include a phone call), a contact (which entails a physical presence by the user), or a task. The categories can be color-coded to differentiate among category types, and for quick identifiable reference by the user when the app later displays each event on the dial.

FIG. 4C illustrates a rendering of untimed indicators. Indicators on the bottom of the interface display the events the app created from user input, but without assigning a specific date or time. When a user taps an indicator, the app reveals icons 402 representing the person or place the user designated for an event. The app may also blur the background of the GUI so as to focus the user's attention to the expanded indicators. FIG. 4D shows a process of highlighting events. The app can represent icons on the dial with images or other graphics, preferably within or associated with the outer region of the dial. For instance, if the event is a “contact” event 404, the app populates the associated icon with an image of the event attendee(s), which can be automatically imported from the user's contacts, or via a newly-acquired photo. If the event is a “meeting” event 406, the app populates the icon with an image or other graphical representation of the place or location of the event. The graphical representation can be an icon. The image or icon can be pre-selected, or can be acquired by the app via an application programming interface (API) to a map application or other geolocation function.

FIGS. 4E and 4F illustrates a process for inviting contacts to events. When a user adds a contact to an event, the app prompts the user to invite the contact to that event. If the user invites the contact, the app then notifies the invitee, preferably via push messaging or other electronic notification system, and gives the invitee an option to accept or decline the invitation, or request a different time and/or location. As shown in FIG. 4F, once the invitee has accepted the invite, which is received electronically by the app, the app coordinates with a local app of the invitee mobile computing device to populate the invitee's own dial with the accepted event. Accordingly, the user who originated the event as well as any invitee that accepts the event are coordinated by the time management system.

As shown in FIG. 4G, if a user clicks on an icon, the app presents the user information about the event. In the example shown in FIG. 4G, a call has been scheduled and the app presents a “call” button within the inner region of the dial, which can be activated by the user to initiate the call. As shown in FIG. 4H, the app can allow a user to edit and adjust details of an event by the user activating an “edit” control, which then directs the app to provide details of the event to be edited within the inner region of the dial, as shown in FIG. 4I. The app also provides user-selectable editing controls along with the details of the event, and by which the user can edit the details. Alternatively, to change a time for the event, as illustrated in FIG. 4J, the app can allow a user to “hold” the icon representing the event, and simply “drag” the icon to a new time represented by the outer region of the dial. The app also represents the change in time within the information dial of the inner region, and allows the user to save or cancel the new time.

In some implementations, the app can be integrated with one or more other applications on the mobile computing device. For instance, the app can be integrated with location services such as mapping or geo-positioning applications. As shown in FIG. 4K, if the user has selected and inputted a location point within a meeting event, one or more location-based features are made available by the app. For example, the app can use geo-location services to calculate a distance to the meeting event location point, as well as calculate a time to destination using traffic or other data, as illustrated by FIG. 4L. Using geo-location, the app is also able to alert the user if the time until the event is growing close to the time to destination that was calculated (and dynamically re-calculated or updated) by the app, in order to allow the user time to make the meeting. As shown in FIG. 4M, the app alerts the user if the user is in the vicinity of a location point set within a task or meeting, which alert can be displayed by the app in the inner region of the dial. FIG. 4N shows a list view of events generated by the app, and that can be navigated to by the user via the app.

As discussed above, in some implementations the app can be integrated with other third party applications. The third party integration can be represented by an icon or other user-selectable control within the inner region of the dial, for instant user access to the third party application through the app. Data collected by the third party application can be displayed by the app on the dial. Other functionality, such as video conferencing, e-commerce, note taking, file sharing and cloud-based document storage, or the like, can also be integrated with and accessible through the app.

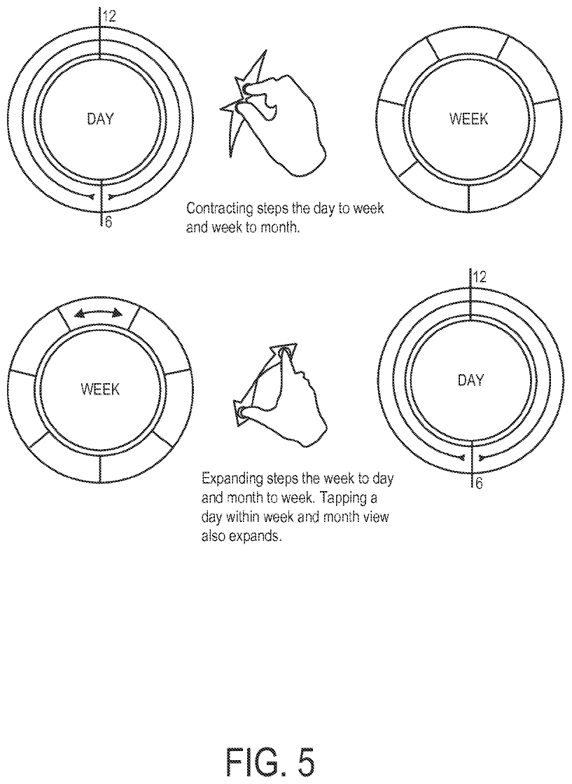

FIG. 5 illustrates functions of switching views in the graphical user interface of the mobile application. The app interprets certain user actions on a touch-sensitive display, for example, to switch views on the display between day, week and month, or any other duration of time. For instance, the user can “pinch” the display or “expand” the display to adjust the view between time durations.

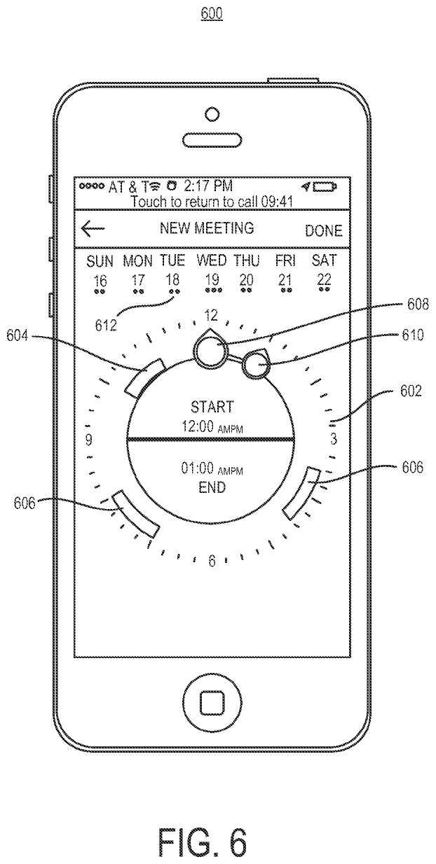

FIG. 6 illustrates a graphical user interface 600 of the app of a time management system in accordance with some implementations. The app provides one or more dials 602. Each dial 602 preferably is displayed by the app to represent a conventional 12-hour clock face or watch dial, in which an outer region of the dial 602 includes designations of hour increments, or other increments, such as increments of 15 minutes. Further, the dial 602 can be associated with an hour hand and a minute hand like a conventional clock, such that the time domain represented by the outer region of the dial can have dual meaning or representation.

The inner region of the dial 602 can display information about meetings, contacts, locations, etc., related to events scheduled using the dial 602. The outer region of the dial 602 can be formed of one or more rings, such as an inner ring 604 and an outer ring 606, to designate twelve hours of AM and 12 hours of PM, respectively. Previously or currently-scheduled events for a displayed day can be shown as sections of the inner ring 604 and/or outer ring 606. The sections extend along the respective ring to designate a time duration of the previously or currently-scheduled events. The sections can be graphically distinct according to event type, such as color-coded as to event type, i.e., red for meetings, yellow for contacts, and green for tasks.

To set up or create a new event on the dial 602, the app displays an event start time handle 608 and an event end time handle 610. In some implementations, the app defaults the display of the event start time handle 608 at the 12 o'clock position on the dial 602, and the event end time handle 610 can be defaulted to display at a one hour duration from the event start time handle 608, i.e., at the 1 o'clock position. In order to utilize a 24 hour day with a 12 hour dial, if a user swipes or moves the event start time handle 608 to one side or in one direction of the default position, i.e. to the left or counter-clockwise, the app represents the event start time as AM. If a user swipes or moves the event start time handle 608 toward the opposite side or direction, i.e. clockwise, the app represents the event start time as PM. The event end time handle 610 either follows the event start time handle 608 to the left or counter-clockwise, maintaining the default duration, or leads the event start time handle 608 to the right or clockwise. The app enables a user to adjust the duration of the new event by manipulating the event end time handle 610 closer to or farther from the event start time handle 608, to respectively shorten or lengthen the new event being scheduled. If the event end time handle 610 is placed on the opposite side of the dial 602 from the event start time handle 608, the event will cross from AM to PM or vice versa. Accordingly, the app allows 24 hour days to be designated and scheduled using a 12 hour dial interface.

The app can also represent individual days in the interface 600, such as a week of seven days, or, by receiving one or more commands from a user such as a swipe on the screen, can display adjacent weeks, an entire month, or adjacent months. Each individual day can include one or more event designators 612 that represent one or more events scheduled for that day. In some implementations, the designators 612 can be equal to the number of events for the day, or can simply represent existence of event types. As such, the one or more designators 612 can be color or graphically coordinated with the event type designation or differentiation scheme used by the app.

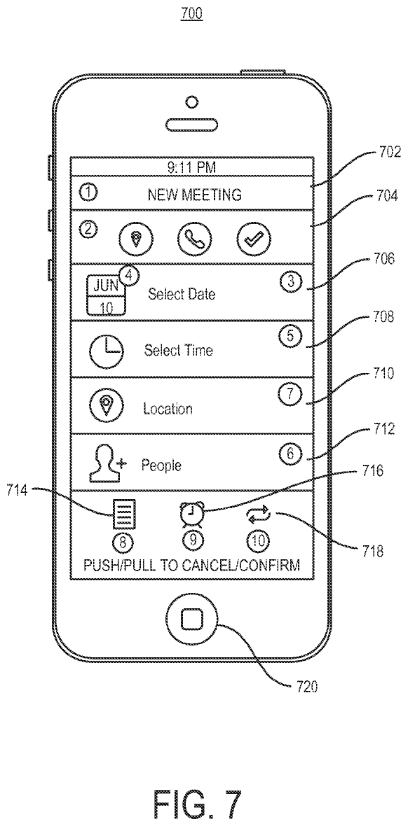

FIG. 7 illustrates another interface 700 of a time management system in accordance with some implementations. The app provides interface 700 for setting up a new event 702. The new event 702 can be selected from a set of event types 704 such as a meeting, a call, or a task. Once an event type 704 is selected, the app allows a user to select a date 706, select a time 708, select a location 710, and or select people to invite 712 for the event. Each of the selections of the date 706, time 708, location 710 and people 712 can display a specific interface for making such selection, such as a contacts list to select people 712, or a map application to select a location 710 for the event. The interface 700 can also include other functionality, such as a note taking function accessible via a notes button 714, an alert function accessible via an alert options button 716, and a repeat options function accessible via a repeat options function 718. These buttons can be implemented graphically on the interface, or associated with a physical input device. The interface 700 can also include a confirm/cancel user instruction button 720, such as the home physical button of a smartphone.

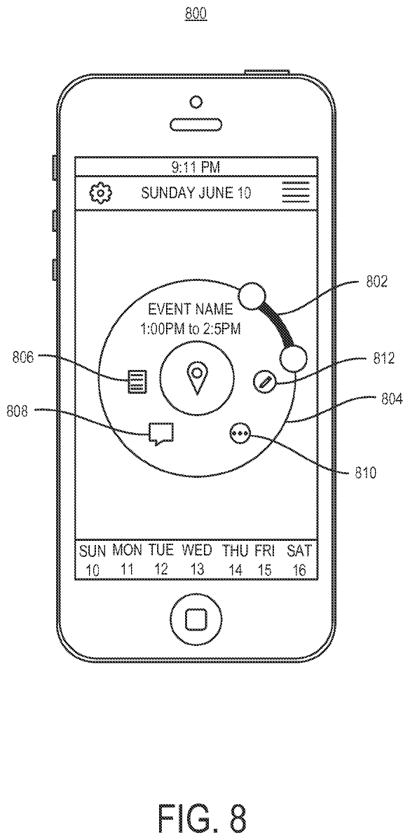

FIG. 8 illustrates yet another interface 800 of a time management system in accordance with some implementations. The interface 800 includes an event 802 graphically represented on a dial 804, as substantially described above. The event 802 can be selected individually from a set of events that are graphically represented on the dial 804 in another interface generated by the app. For each event, the app provides a note taking function accessible by a notes button 806. The app also provides in-app messaging 808 accessible via a messaging button 808. User selection of the messaging function can provide a messaging interface to receive a text message that is automatically addressed to all event invitees, or can be initially unaddressed, while the user is enabled to include message recipients. The in-app messaging 808 can also automatically include other event-related information in the message to be sent to the recipients. Accordingly, the app provides a fully integrated messaging and networking capability with the event scheduling and time management capabilities.

The interface 800 can also include a summary view button 810 by which the user can access a summary view of the event provided by the app. The summary view can display the event date, time, location, and/or people associated with the event, in graphical or textual form, or any combination thereof. The interface 800 can further include an event edit button 812 to enable a user to edit the attributes of the event, such as the date, time, location, and/or people, and/or event type.

Once an event is formed or created by the app under direction of a user, invitees are sent an invitation. For invitees that do not currently have the app on their mobile computing devices, the invitation can include a link or the like for enabling the invitee to download the app to their mobile computing device. Accordingly, the attendees of an event—including the event creator and any invitees—are completely synchronized and integrated via the app. Future invitations can occur via the app only.

The app may display one or more dials, and the one more dials can be designated to or associated with different people, different entities, different projects, etc. The app can enable a user to switch among two or more dials, by graphically displaying them and highlighting a selected dial.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable or programmed data processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT), a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

1. A time management system comprising:
a graphical user interface generated by an application on a mobile computing device, the graphical user interface being displayed on a touch-sensitive display of the mobile computing device and comprising a substantially circular dial, the dial having an outer region and an inner region circumscribed by the outer region, the outer region representing a time domain and displaying one or more icons thereon to represent an associated one or more events to occur at a time of the time domain, the inner region displaying information relating to at least one user selected event represented by the one or more icons in the outer region, the inner region further providing interactive controls for editing the information relating to the at least one user selected event.

2-10. (canceled)
